(19) United States
(12) Patent Application Publication
(10) Pub. No.: US 2026/0092881 A1
(43) Pub. Date: Apr. 2, 2026

(54) DEEP TECHNOLOGY-BASED SYSTEM THAT PROVIDES THREE- DIMENSIONAL IMAGING OF A TUMOR

(71) Applicant: Adem POLAT, Canakkale (TR)

(72) Inventor: Adem POLAT, Canakkale (TR)

(21) Appl. No.: 19/110,828

(22) PCT Filed: Sep. 12, 2023
(86) PCT No.: PCT/TR2023/050948

§ 371 Date: Mar. 12, 2025

(30) Foreign Application Priority Data
Sep. 13, 2022 (TR) 2022/014148

(51) Int. Cl. G01N 23/046

(52) U.S. Cl. CPC G01N 23/046; G01N 2223/309; G01N 2223/3306

(57) ABSTRACT

The provided is a system that provides information with high accuracy by performing voxel-based both cross-sectional and volumetric three-dimensional imaging in cancer tissues, especially in determining the necessary surgical margins of the breast tumor removed from the patient with breast cancer surgery and the presence of the tumor in the sentinel lymph node, which is the first lymph node from which the tumor drained. The provided will not be applied directly to humans and the human body, but to the tumor and/or tumorous tissue removed from the patient's cancerous organ (especially the breast). By changing the software parameters and the applied X-ray range used in breast tumors, a deep technology-based system developed can also be used in human lung, liver, pancreas, thyroid, brain, skin, small intestine, large intestine, stomach, gall bladder, esophagus, bladder, kidney, ovary, uterus, cervix, testis and prostate tumors and tumorous tissue fragments.

### CROSS-REFERENCE TO THE RELATED APPLICATIONS

This application is the national phase entry of International Application No. PCT/TR2023/050948, filed on Sep. 12, 2023, which is based upon and claims priority to Turkish Patent Application No. 2022/014148, filed on Sep. 13, 2022, the entire contents of which are incorporated herein by reference.

### TECHNICAL FIELD

The subject of the invention relates to a voxel-based three-dimensional imaging system that provides information with high accuracy by performing both cross-sectional and volumetric three-dimensional imaging in cancer tissues, especially in the detection of the required surgical margins of the breast tumor removed from the patient with breast cancer surgery and the presence of the tumor in the sentinel lymph node, which is the first lymph node from which the tumor drains. The system, which is developed based on deep technology, will not be applied directly to humans and the human body, but will be applied to the tumor and/or tumorous tissue removed from the patient's cancerous organ (especially breast). By changing the software parameters and the applied X-ray range used in breast tumors, the developed deep technology-based system can be used in tumors and tumorous tissue fragments removed from human lung, liver, pancreas, thyroid, brain, skin, small intestine, large intestine, stomach, gallbladder, esophagus, bladder, kidney, ovary, uterus, cervix, testis and prostate.

### BACKGROUND

Deep technology is defined as a technology based on scientific developments and discoveries. Deep technology starts with science and scientific research and continues with research and development (R&D) activities that include academic and theoretical approaches. It is differentiated from mainstream technology initiatives that deal with business model innovation, service improvements, internet, mobile, e-commerce, engineering applications, routine and traditional R&D. Deep technologies are technologies that are based on scientific research and technologies, fed from laboratories, and require more complex and lengthy R&D processes and research infrastructures. Since deep technology systems are today's most advanced technology trend, deep technology developments are important.

Breast cancer is cancer cells that form in the milk ducts within the breast tissue. The cells that cause breast cancer can spread through lymph and blood. Therefore, early diagnosis is very important in breast cancer and the devices used in the diagnosis of breast cancer and in the removal and examination of the tumor after diagnosis are of great importance.

In the known state of the art, the breast tumor and the sentinel lymph node, which is the first lymph node from which the tumor drains, removed from the patient by the surgeon during breast surgery, are frozen by pathologists using the traditional pathology/frozen method and sliced at the micron level with a microtome device. Each slice is examined under a microscope by a pathologist using two very critical traditional pathology/frozen methods. The first of these methods and the problems encountered are as follows.
1) Urgent pathology is a superficial pathological examination performed while the patient is under anesthesia with an open incision on the operating table.

### Disadvantages

The patient is kept on the operating table for at least 1.5 hours under anesthesia with an open incision.
There are long analysis or testing times. If there is an in-house pathology laboratory, this can be as long as 2.5 hours.
The patient is kept waiting for a long time and therefore the risk of infection is quite high due to the waiting time.
The pathology laboratory and specialist are not available in every hospital or city.
The rate of error is high due to rushed and superficial examination.
The success of the operation varies according to the personal experience of the surgeon or pathologist.
The procedure is performed by a surgeon or pathologist, so there is a human error factor (lack of experience-fatigue).
The breast tumor is physically cut and sliced.
Each slice is examined individually by the pathologist with a 2D microscope.
The sliced breast tumors are at risk of rupturing and/or deforming.
The operating room is occupied for an additional two hours.

The second method and the problems encountered are listed below.
2) Detailed pathology is a detailed pathological examination of a breast tumor removed from a patient.

### Disadvantages

The final/detailed pathology report is prepared in approximately 30 days.
The breast tumor is physically cut into slices as in urgent pathology and each slice is examined individually by the pathologist using a 2D microscope.
The process is physically exhausting and labor-intensive.
The tumor detection success is highly dependent on human factors. Therefore, it is very prone to error.
The procedure is performed by a surgeon or pathologist, so there is a human error factor (lack of experience-fatigue).
The sliced breast tumors are at risk of rupturing and/or deforming.
The diagnosis is incorrect in approximately 15% of patients, and accordingly, 15% of patients inevitably undergo a second operation.
The specialist and pathological examination laboratory facilities are not available in all hospitals and provinces.

In the known state of the art, the United States patent US2008089471A1, which is used in the diagnosis and detection of breast cancer and is directly applied to humans, mentions that a medical breast image capturing apparatus comprises an aperture element (3) for exposing the breast of a test subject. It includes the horizontally rotating arm (4), X-ray tube (5), detector (6), controller (8), rotary driver (7), guide (15), and a biopsy instrument (22) that moves in accordance with the guide. In the known state of the art, the United States patent document US2009080604A1, which is used in the diagnosis and detection of breast cancer and applied directly to humans, mentions a medical imaging and biopsy system. It includes elements such as biopsy system (100), X-ray source (111), an arm that provides movement (112), detector (114).

In the known state of the art, the Korean patent document KR20110016527A, which is used in the diagnosis and detection of breast cancer and directly applied to humans, mentions the development of a breast tissue strain imaging apparatus that uses X-ray to accurately diagnose breast cancer using a weak compressed image and a strong compressed image. A data acquisition device (106) takes an X-ray image of a breast. A rotation axis (202) rotates an X-ray tube (101) and an X-ray detector (103). The breast compressor (104) controls the compression intensity of the breast. An image reconstruction device (107) includes a cross-sectional image of the breast. A strain calculation device (108) calculates a spatial distribution in a cross-sectional image of the breast. An image display device (109) shows the image with a spatial distribution. The system includes X-ray tube (101), X-ray generator (102), X-ray detector (103), breast compressor (104), system control unit (105), data acquisition device (106), image correction device (107), image display device (109), platform (201), motor and rotation axis (202) for angular movement of the platform (201).

In the known state of the art, the U.S. Pat. No. 10,098,600B2, which is used in the diagnosis and detection of breast cancer and applied directly to humans, mentions a conical breast beam (CBBCT), high soft tissue contrast, high spatial resolution, and a three-dimensional breast imaging device and method that prevents tissue overlap. CBBCT-based computer-aided diagnostic technology is a clinically useful device that will help radiologists make more efficient and accurate decisions for breast cancer detection and diagnosis. CBBCT-CAD can do the following: 1) can use 3D algorithms for image correction, mass and calcification detection and characterization, duct imaging and segmentation, vessel imaging and segmentation, and breast density measurement, 2) provides combined information of the breast including the mass, and calcifications, duct structure, vascular structure, and breast density are presented to radiologists to assist them in determining the possibility that the breast lesion is a malignant tumor. The system also converts images into voxel form using a fuzzy clustering algorithm. It includes detector (208), X-ray tube (210), protection shield (205), motor (214) for vertical movement.

In the known state of the art, the Türkiye patent document numbered 2021/01433, which is used in the diagnosis and detection of cancer tissue and applied directly to humans, mentions the determination of the surgical margin with photodynamic diagnosis in cancers that cause metastasize to the peritoneum spreading into the breast cancer and abdomen, the determination of the surgical margin of cancerous tissue during surgery, and the use of this technique in both technical tool development and treatment. Thanks to the invention in question, the accuracy of the disease of the patient detected by the imaging method performed before the operating table will be determined once again on the operating table.

In the known state of the art, the Türkiye patent document 2021/014796, which is used in the diagnosis and detection of cancer tissue and applied directly to humans or animals, mentions a personalized disposable device used in the cleaning or sampling of the tumor by precisely detecting the position/location of the tumor in human or animal bones. In the surgical stage, only the tumor is intervened, and the operation is completed without touching the clean tissue.

However, the tumor imaging devices in breast cancer present in the submitted patent documents are directly applied to the human being and the human body, whereas this invention is applied to the tumor or tumorous tissue fragment surgically removed from the human being. In addition, the tumor imaging devices in breast cancer present in the submitted patent documents, there is no system that outputs the tumor in the form of voxels detecting it in three dimensions and determines the boundaries to be removed (the required surgical margin) with high accuracy by detecting the proximity of the tumor to the clean healthy border. In the known state of the art, the determination of this border is performed by the conventional pathology method and there is no system that determines the required surgical margins of the tumor removed from the patient and its presence in the sentinel lymph node. Therefore, there is a need to develop a deep technology-based system that enables three-dimensional imaging of the tumor removed from the patient, mapping the required surgical margin, determining the presence of the tumor in the sentinel lymph node, and providing three-dimensional imaging of the tumor using deep technology.

### SUMMARY

The main objective of this invention is the realization of a deep technology-based system that enables three-dimensional imaging of the tumor removed from the patient in breast cancer surgery, achieving a high success rate of 86%-99% in accurately determining required surgical margins by assessing tumor proximity to healthy tissue and enabling the provision of three-dimensional image of the tumor.

Another objective of the present invention is the realization of a deep technology-based system that can detect the presence of the tumor in the sentinel lymph node, which is the first lymph node from which the tumor drains, with high accuracy by performing three-dimensional imaging and enabling the provision of three-dimensional imaging of the tumor.

Another objective of the present invention is the realization of a deep technology-based system that enables the mapping and reporting of the required surgical margin of the three-dimensionally imaged tumor and the presence of the tumor in the sentinel lymph node with artificial intelligence and enabling the provision of three-dimensional imaging of the tumor.

Another objective of the present invention is the realization of a deep technology-based system that enables three-dimensional imaging of the breast tumor in a short period of time, approximately 5 to 25 minutes, depending on the size of the breast tumor.

Another objective of the present invention is the realization of a deep technology-based system that enables the patient not to be kept under anesthesia for a long time (e.g. 1.5-2.5 hours) with an open incision and thus to avoid complications in the patient and enabling the provision of three-dimensional imaging of the tumor.

Another objective of the present invention is the realization of a deep technology-based system that enables the operating room and pathology laboratory not to be occupied for long periods of time (1.5-2.5 hours) while waiting for the pathology result and enabling the provision of three-dimensional imaging of the tumor.

Another objective of the present invention is the realization of a deep technology-based system that allows the breast tumor to be imaged in three dimensions as a whole, avoiding the need to physically cut and dissect the breast tumor.

Another objective of the present invention is the realization of a deep technology-based system that enables a deep technology-based examination independent of the human factor in the detection of breast tumors and allows for a reduction in the error rate and enabling the provision of three-dimensional imaging of the tumor.

Another objective of the present invention is the realization of a deep technology-based system that enables three-dimensional imaging of the tumor, where three-dimensional imaging parameters are defined in a practical way from an easy-to-use system programming panel and computer interface, and accordingly, the results can be obtained in the form of both three-dimensional volumetric imaging and three-dimensional cross-sectional imaging based on voxels.

Another objective of this invention is the realization of a deep technology-based system that can be easily transported between operating rooms thanks to its portability and enables three-dimensional imaging of the tumor.

Another objective of this invention is the realization of a deep technology-based system that can be used in human lung, liver, pancreas, thyroid, brain, skin, small intestine, large intestine, stomach, gallbladder, esophagus, bladder, kidney, ovary, uterus, cervix, testis and prostate tumors and tumorous tissue fragments by changing the software parameters and the applied X-ray range used in breast tumors, enabling three-dimensional imaging of the tumor.

### BRIEF DESCRIPTION OF THE DRAWINGS

A deep technology-based system for three-dimensional imaging of a tumor with deep technology realized to achieve the objects of the present invention is shown in the attached figure.

This figure;

FIG. 1: Schematic view of the front side of a deep technology-based system for three-dimensional tumor imaging.

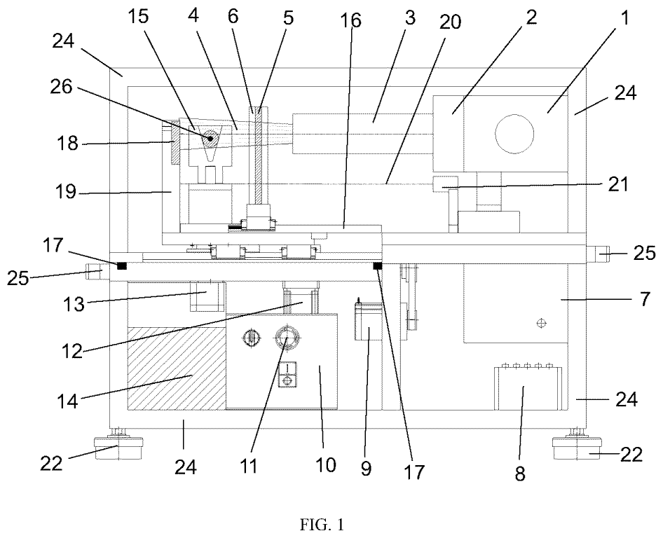

FIG. 2: Perspective view showing the front side of a deep technology-based system that enables three-dimensional imaging of the tumor.

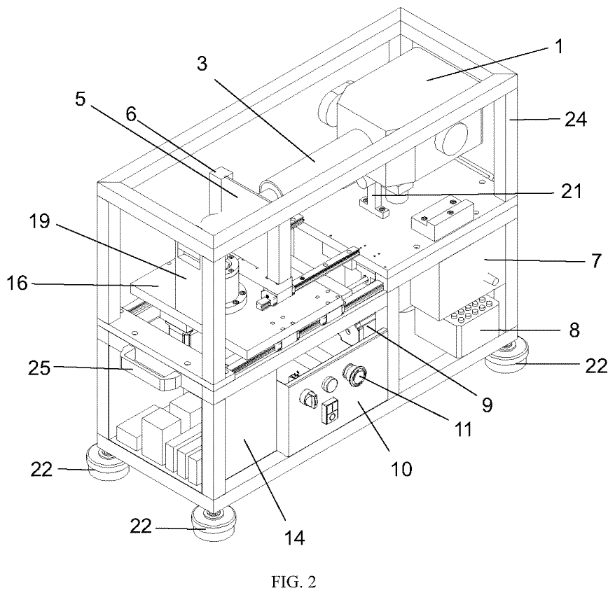

FIG. 3: Perspective view showing the front side of a deep technology-based system for three-dimensional imaging of a tumor.

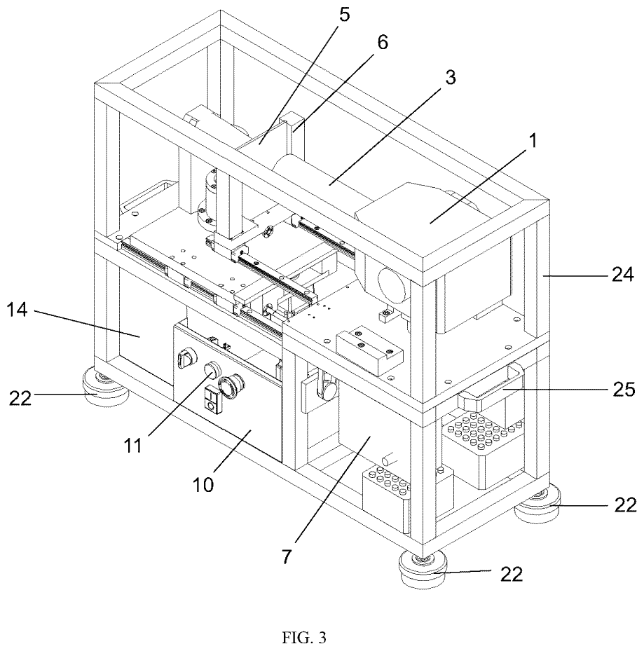

FIG. 4: Schematic view of the back side of a deep technology-based system for three-dimensional imaging of a tumor.

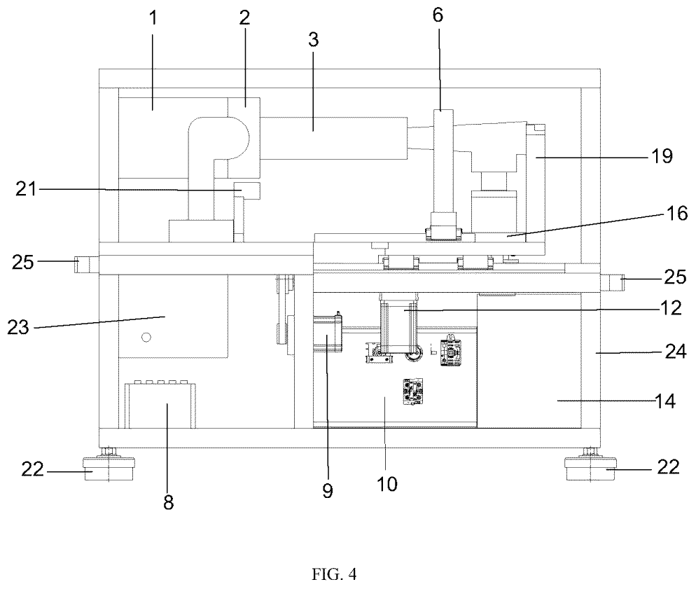

FIG. 5: Perspective view showing the back side of a deep technology-based system for three-dimensional imaging of a tumor.

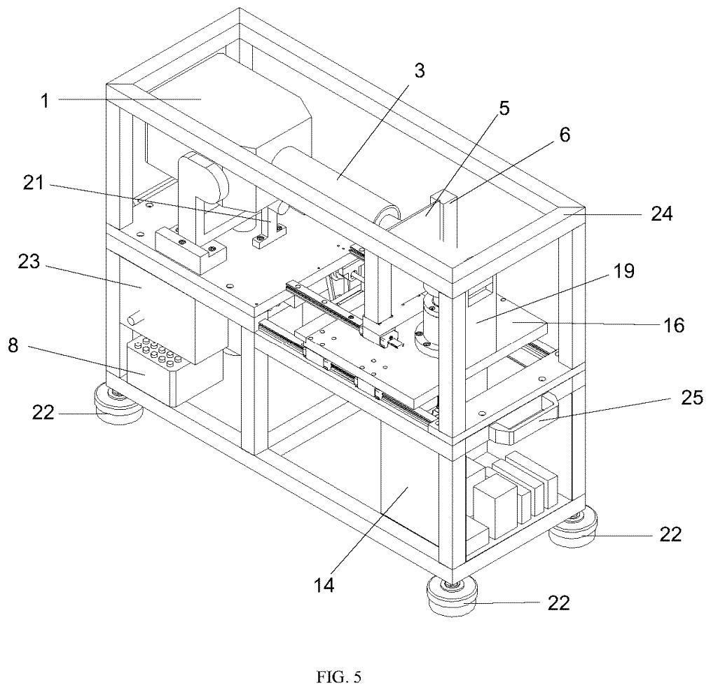

FIG. 6: Perspective view showing the back side of a deep technology-based system for three-dimensional imaging of a tumor.

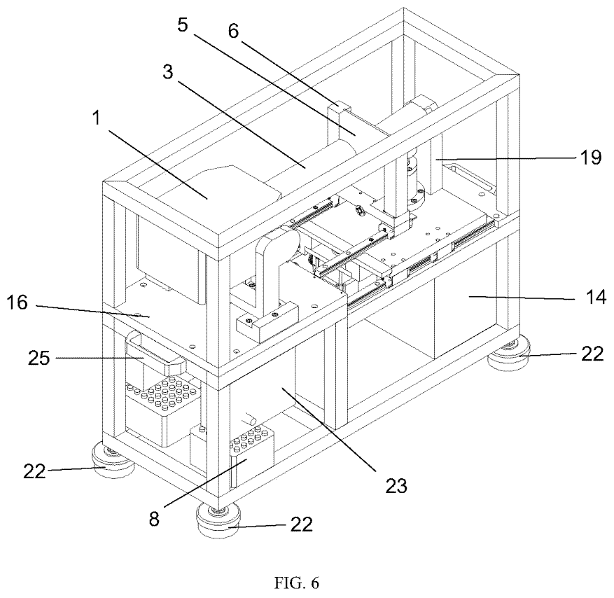

The parts in the figures are numbered one by one and the equivalents of these numbers are given below.
1. X-ray generator
2. X-ray tube
3. X-ray guide
4. X-ray
5. X-ray filter
6. X-ray filter unit
7. X-ray control unit and timer
8. X-ray back-up generator set
9. Horizontal motion control motor
10. Energy control panel
11. Emergency stop button
12. Angular scanning control motor
13. Vertical motion control motor
14. Electronic control unit
15. Conical tumor holder
16. Angular scanning platform
17. Limit switch
18. Detector
19. Detector platform
20. Laser beam
21. Laser measuring unit
22. Leveled and adjustable legs
23. System programming panel
24. X-ray absorption shield
25. Transport handles
26. Tumor

### DETAILED DESCRIPTION OF THE EMBODIMENTS

The invention is a system for three-dimensional imaging of the tumor (26) with deep technology, comprises;
an X-ray generator (1), which is responsible for producing X-rays (4) within this developed system,
an X-ray tube (2) connected to the X-ray generator (1) and generating X-rays (4),
an X-ray guide (3), which is connected to the X-ray tube (2) and gives the X-rays (4) horizontal orientation by being adjustable in various lengths for the beam geometry,
an X-ray filter (5) located in front of the X-ray guide (3) and used to fine-tune the X-ray (4) values,
an X-ray filter unit (6) located in front of the X-ray guide (3), where the X-ray filter (5) is placed,
an X-ray control unit and timer (7) connected to the X-ray generator (1) and responsible for setting the energy to be applied and sending the trigger command to start the X-ray (4) irradiation,
an X-ray backup generator set (8), which is connected to the X-ray tube (2) and used to produce X-rays (4) at the desired range if required,
a horizontal motion control motor (9), which is included in this system and allows the horizontal motion to be adjusted to the calculated optimum distance,
an energy control panel (10), which is connected with this developed system and provides the necessary electrical energy to the system,
an emergency stop button (11) on the energy control panel (10), which allows the system to stop and terminate all functions of the system by de-energizing the system in case of emergency,
an angular scanning control motor (12), which is connected to the energy control panel (10) and provides the tumor (26) with angular rotational movement around its own axis,
a vertical motion control motor (13), which is included in this system and provides movement in the vertical axis for the vertical position adjustment of the tumor (26),
an electronic control unit (14) connected to the horizontal motion control motor (9), the angular scanning control motor (12) and the vertical motion control motor (13) and enabling control of the horizontal motion control motor (9), the angular scanning control motor (12) and the vertical motion control motor (13),
a conical tumor holder (15), which is connected to the vertical motion control motor (13), stabilizing the tumor (26) without deforming its shape,
an angular scanning platform (16), which is connected to the conical tumor holder (15) and rotates the tumor (26) horizontally around its own axis, minimizing vibration and shaking,
at least two limit switches (17) controlling the maximum and minimum travel distance of the angular scanning platform (16) in the horizontal axis, connected to the horizontal motion control motor (9) and controlled by the electronic control unit (14),
a detector (18) located at the top of the angular scanning platform (16), opposite the X-ray tube (2), where the X-rays (4) to be irradiated from the X-ray tube (2) are incident vertically in the horizontal plane,
a detector platform (19) connected to the detector (18), located opposite the X-ray tube (2) and allowing X-rays (4) to reflect perpendicular to the detector (18),
a laser measuring unit (21) in this system, which uses a laser beam (20) to determine the horizontal position of the detector (18) and the X-ray tube (2),
leveled and adjustable legs (22) with pneumatic sensor apparatus and an anti-vibration system at the bottom of this system, which ensures that the system is placed parallel and stable to the ground on which it sits,
a system programming panel (23), which is connected to the energy control panel (10) and enables programming and control of all hardware and software functions of the system,
an X-ray absorption shield (24), which surrounds this developed system and is used to prevent X-rays (4) from scattering outside the system,
transport handles (25) located on the front and rear parts of this developed system and used for easy mobile transportation of the system.

The method of a deep technology-based system that enables three-dimensional imaging of the tumor (26) with the developed deep technology comprises the steps;
positioning of the detector (18) to the initial position after distance detection with the laser beam (20) to ensure precise calculation of the beam geometry, which is critical for both three-dimensional cross-sectional and three-dimensional volumetric imaging of the tumor (26),
collecting two-dimensional images from different angles with the detector (18) with parameters (number of images, scan angle range, scan angle step, distance between detector (18) and X-ray tube (2), etc.) determined by the system and defined by the system programming panel (23),
calculating the dimensions of the x-y-z axis of the three-dimensional image and the resolutions in the three axes according to the area occupied by the tumor (26) fragment and the dimensions of the image frame in the collected two-dimensional images,
creating voxel-based cross-sectional three-dimensional images according to the x-y-z dimensions and three-axis resolutions of the three-dimensional image calculated with advanced three-dimensional imaging software from two-dimensional images collected from different angles thanks to this system developed,
mapping and reporting of the required surgical margin of the tumor (26) in each section of three-dimensional cross-sectional images with an artificial intelligence algorithm,
volumetric visualizing of three-dimensional images as voxel-based.

The main frame and machine dynamics of the developed system are designed in such a way that shaking and vibration are minimized. For horizontal axis imaging, an X-ray tube (2) and X-ray generator (1) are mounted on a horizontal surface (parallel to the x-axis), and a horizontal X-ray guide (3) is used to guide X-rays (4) in a horizontal plane (parallel to the x-axis) to the detector (18). For the horizontal X-rays (4) to fall perpendicular to the detector (18), the detector (18) is positioned on the detector platform (19) parallel to the vertical axis (y-axis) and perpendicular to the horizontal axis (x-axis). By driving the horizontal motion control motor (9) with the electronic control unit (14), the angular scanning platform (16) is moved automatically to the initial position on the horizontal axis, then to the optimum distance of the detector (18) from the X-ray tube (2), calculated with the parameters set by the system programming panel (23). The correct position is calculated by the laser beam (20) and the laser measuring unit (21). The electronic control unit (14), which receives the correct position information, activates the detector (18) for irradiation and sends a trigger command to the X-ray control unit and timer (7) to irradiate the X-ray (4). A correlation between the kV-mAs values of the first reference projection taken at 0° and the image clarity and quality is calculated with an artificial intelligence algorithm. mAs values are obtained by a combination of a current value in the range of 1 mA-400 mA and X-ray (4) applied for a duration of 1 ms-10000 ms. For example, for 100 mAs X-ray (4), a combination of; i) 100 mA current and 1 second duration or ii) 200 mA current and 500 milliseconds (0.5 seconds) duration is used. These values are obtained by the X-ray control unit and timer (7). On the other hand, depending on the size and thickness of the tumor (26), the number of image frame pixels and resolution parameters change. Depending on the penetration of the X-ray (4) into the tumor (26), an X-ray generator (1) is used to produce the X-ray (4) range in the 10 kV-77 kV band or a narrower range (e.g. 28 kV-32 kV); an X-ray backup generator set (8) is used in the system to produce the X-ray (4) range in a narrower range than the 10 kV-77 kV band. In addition, a suitable filter (0.1 mm-5 mm Al) from the X-ray filter (5) set (0.1 mm-5 mm Al) placed in the X-ray filter unit (6) is used to fine-tune the 10 kV-77 kV values, if needed. After the tumor (26) placed in the conical tumor holder (15) is stabilized without deforming its shape, the vertical positioning of the image of the tumor (26) on the detector (18) is centered by the vertical motion control motor (13). The position, fixation and image quality of the tumor (26) are adapted for angular scanning. The system programming panel (23) and electronic control unit (14) are used to control the angular scanning control motor (12) in accordance with the defined parameters (e.g. 11 projections in ±25° angle range with 5° angle step, or 21 projections in ±10° angle range with 1° angle step, or 2° angle step in ±360° angle range, 180 projection) two-dimensional tumor (26) images collected by the detector (18) at targeted angles and within the specified time (e.g. 0.5 seconds or 3 seconds or 100 milliseconds depending on the X-ray (4) irradiation) are saved in the corresponding projection (two-dimensional) folder with sequence numbers.

The limited angles (e.g. ±50° or ±90°) and limited number of projections (7-180) collected from the breast tumor (26) are used for voxel-based three-dimensional cross-sectional imaging of the tumor (26) with the advanced three-dimensional image reconstruction software developed for the system, and 10-200 sections (z-axis dimension) with pixel dimensions (20-150 μm/pixel resolution depending on tumor (26) and image size) of 200×200−4000×4000 (x-y axis dimensions) varying according to the tumor (26) dimensions are obtained in each section. The x-y dimensions can be either the same or different. This enables three-dimensional cross-sectional imaging with voxel sizes ranging from 200×200×10 to 4000×4000×200 (e.g. 453×453×72 or 453×628×18 or 2816×3684×177). Then, the required surgical margin between the tumor (26) and the clean area is mapped with the artificial intelligence algorithm and a short and understandable report is generated for each section and presented to the surgeon and pathologist. The developed deep technology-based system includes an advanced three-dimensional imaging software and artificial intelligence algorithm that enables voxel-based visualization and three-dimensional volumetric rendering of images.

The angular scanning platform (16) minimizes shaking and vibration by rotating the much lighter tumor (26) around its axis on the horizontal axis instead of rotating the heavy X-ray tube (2), X-ray generator (1) (or X-ray backup generator set (8) used to produce X-rays (4) at the desired range if needed), detector platform (19) and detector (18), taking into account the direction of gravity.

The conical tumor holder (15) is designed in a tapered shape since the tumor (26) removed from the patient may vary in size. Thus, the tumor (26) is fixed by its own weight, regardless of its size, in the conical tumor holder (15) without disturbing its natural structure. X-ray (4) and detector (18) are located in the same horizontal plane facing each other. The detector platform (19) is horizontally movable only for distance adjustment without angular movement. In other words, the detector platform (19) moves on the horizontal axis for positioning relative to the X-ray tube (2), but does not move angularly. The conical tumor holder (15) is angularly rotated 360° around its own axis while maintaining the same height vertically by controlling the angular scanning control motor (12) fixed to the angular scanning platform (16) with the electronic control unit (14). By rotating the tumor (26) in the conical tumor holder (15) 360° around its axis, the function of collecting projections (two-dimensional images) from different angles, which is very critical for advanced three-dimensional imaging software and artificial intelligence algorithms used in three-dimensional imaging of the tumor (26) with deep technology, is fulfilled. The vertical position adjustment of the conical tumor holder (15) is made by the vertical motion control motor (13) in order to center the tumor (26) placed on the conical tumor holder (15), which can be rotated 360° angularly around its own axis, to the detector (18) on the vertical axis according to the size diversity.

The dimensions of the detector (18) can vary between 20 mm×20 mm and 400 mm×400 mm. The structure of the detector (18) does not have to be square, but can also have different aspect dimensions (e.g. 240 mm×300 mm). It is capable of detecting 10 kV-225 kV X-ray energy in the operating range. In order for the detector (18) to continuously receive X-rays (4) at right angles (90°), the detector (18) is positioned perpendicular to the X-ray tube (2). The detector (18) is not rotated angularly. The three-dimensional imaging of the tumor (26) is performed by angularly rotating the conical tumor holder (15) 360° around its axis and collecting projections at the specified angle range and angle step, which is very critical for advanced three-dimensional imaging software and artificial intelligence algorithm.

Since the distance between the detector (18) and the X-ray tube (2); the distance between the tumor (26) and the X-ray tube (2), and the distance between the tumor (26) and the detector (18) must be calculated very precisely to ensure stable beam geometry in voxel-based volumetric and cross-sectional three-dimensional imaging technology, the detector (18) and the conical tumor holder (15) are moved horizontally to adjust their distance to the fixed X-ray tube (2).

The detector (18) can be moved by the horizontal motion control motor (9) for distance adjustment on the horizontal axis. Once the positions of the detector (18), tumor (26) and X-ray tube (2) are determined, the conical tumor holder (15) containing the tumor (26) is rotated around its axis to collect projections from different angles while the detector (18) and X-ray tube (2) are kept stationary. This ensures a stable beam geometry. Achieving stable beam geometry is crucial for voxel-based volumetric and cross-sectional three-dimensional imaging technology.

The X-ray guide (3) is available in various sizes (such as 5 cm-30 cm length) for beam geometry. For this reason, the X-ray filter unit (6) in which the X-ray filter (5) is placed in front of the X-ray guide (3) is horizontally movable.

The distance between the X-ray tube (2) and the detector (18) is automatically calculated with the laser beam (20) projected from the laser measuring unit (21) according to the result of the image sharpness evaluation of the tumor (26) by the advanced three-dimensional imaging software and artificial intelligence algorithm.

Thanks to the balance indicator on the leveled and adjustable legs (22) placed under the system, it is ensured that the system is parallel to the horizontal axis plane by adjusting the balance indicator on the system, so that the plane centers of the tumor (26) images taken from different angles are placed on the same axis and thus geometric shifts in the images are prevented. In addition, thanks to the pneumatic sensor apparatus and anti-vibration system placed on the leveled and adjustable legs (22), the device operates smoothly and the image center remains constant at every angle change, thus preventing geometric artifacts on the images.

Thanks to its portable feature, the system can be moved easily as it is a portable device. The system, which can be placed on a lightweight trolley system with brakes, is portable, i.e. mobile, and can be easily used between operating rooms.

The X-ray (4) kV-mAs (mAs: combination of mA and ms) values to be applied to the breast tumor (26) in each patient are dynamically determined for each image according to the artificial intelligence algorithm. The resolution is dynamically determined according to the pixel area occupied by the breast tumor (26) and the dimensions of the image frame. Accordingly, the number of voxels in three axes (x-y-z-axes) of the three-dimensional image is calculated. The number of image slices is determined according to the number of voxels in the z-axis, which gives the depth (thickness) information of the tumor (26).

Using an artificial intelligence algorithm and advanced three-dimensional cross-sectional imaging, the tumor (26) structure and necessary surgical margins are mapped for each slice. In addition, three-dimensional volumetric imaging including all slices is visualized and the tumor (26) structure and necessary surgical margins are examined by rotating 360° in three axes. Unlike conventional three-dimensional scan images, volumetric visualization contains not only surface information, but also information about each point that makes up the volume, i.e. voxels.

The laser measurement unit (21) provides distance measurement and automatic determination of the imaging starting position by means of the laser beam (20). The distance between the X-ray tube (2), the detector (18) and the tumor (26) is automatically determined by the laser measurement unit (21), after which the detector (18) and the tumor (26) are moved to the imaging initial position for precise calculation of the beam geometry, which is critical for voxel-based three-dimensional imaging.

Three-dimensional cross-sectional and volumetric imaging is voxel-based imaging obtained with a beam algorithm. It should not be confused with stereo images. The basic technique of stereo imaging is to present offset two-dimensional images that are displayed separately to the left and right eye. Both of these offset two-dimensional images are then combined in the human brain to give the perception of three-dimensional depth. The human eye views the surface shape of objects, not their internal structure. Although the term “three-dimensional imaging” is used in many fields, it is important to note that it is distinctly different from the visualization of two-dimensional images in three dimensions.

The advantages obtained with a deep technology-based system that enables three-dimensional imaging of the developed tumor are listed below.
The tumor (26) removed from the patient allows three-dimensional voxel-based cross-sectional and volumetric imaging of the tumor (26) with advanced three-dimensional imaging software in a short period of approximately 5-25 minutes depending on the size of the tumor (26) at the time of surgery.
With artificial intelligence-based mapping, the surgical margin required for complete removal of the tumor (26) and the spread of the tumor (26) from the sentinel lymph node in the armpit can be determined. Due to its rapid detection (approximately 5-25 minutes), the surgeon can decide on the course of surgery without closing the open incision in the patient during surgery.
The patient is not kept under anesthesia for long periods of time, preventing further complications.
The operating room and pathology laboratory are not occupied for long periods of time waiting for the pathology result, resulting in increased labor savings.
There is no need to physically cut and dissect the breast tumor (26). Thanks to the developed system, it is possible to visualize the tumor (26) as a whole in three dimensions.
The error rate is reduced due to a deep technology-based examination independent of the human factor.
Thanks to the portable feature of the system, it can be easily carried into the operating room as it is a portable device, and as soon as the three-dimensional imaging and tumor (26) examination is finished, it can be taken to another operating room if necessary, allowing the tumor (26) to be imaged on site during the other operation. Thus, the risks that may occur during the transportation of the tumor (26) within the hospital were protected.
The easy-to-use system-programming panel (23) and computer interface provide a system that operates with a few keystrokes, allowing the surgeon or pathologist to easily obtain the results themselves.
The false negative rate, which is 15% in conventional pathology results, has been reduced by the developed system. The developed system has a low false negative rate (1%-14%) and a high success rate (86%-99%) in determining the required surgical margin and the presence of tumor (26) in the sentinel lymph node.
With the developed system, a second operation is required in a lower percentage of existing patients (1%-14%), while 15% of patients require a second operation with the methods and systems known in the state of the art. Therefore, the need for a second operation has been reduced thanks to the high success of the system (86%-99%).

In breast tumor (26), by collecting a limited number of projections with 1°-5° angle steps, 7-180 projections from a limited angle will provide input information to the three-dimensional imaging software, results will be obtained in 5-25 minutes, and damage to the breast tissue, which is very sensitive to radiation, will be prevented before pathology.

What is claimed is:

1. A deep technology-based system for three-dimensional imaging of a tumor comprising:
an X-ray generator, wherein the X-ray generator is located within the deep technology-based system and is responsible for generating X-rays,
an X-ray tube connected to the X-ray generator and generating the X-rays,
an X-ray guide, wherein the X-ray guide is connected to the X-ray tube and gives the X-rays horizontal orientation by being adjustable in various lengths for beam geometry,
an X-ray filter located in front of the X-ray guide and configured to fine-tune X-ray values,
an X-ray filter unit located in front of the X-ray guide, where the X-ray filter is placed,
an energy control panel, wherein the energy control panel is connected to the deep technology-based system and provides necessary electrical energy to the deep technology-based system,
comprising:
a horizontal motion control motor, wherein the horizontal motion control motor is located within the deep technology-based system and allowing horizontal motion to be adjusted to a the calculated optimum distance,
an angular scanning control motor, wherein the angular scanning control motor is connected to the energy control panel and provides angular rotational movement of the tumor around an axis of the tumor,
a vertical motion control motor, wherein the vertical motion control motor is located in the deep technology-based system and provides movement in a vertical axis to adjust a vertical position of the tumor,
a conical tumor holder, wherein the conical tumor holder is connected to the vertical motion control motor, stabilizing the tumor without deforming a shape of the tumor,
an angular scanning platform, wherein the angular scanning platform is connected to the conical tumor holder and rotates the tumor horizontally around the axis of the tumor, minimizing shaking and vibration,
an X-ray control unit and timer connected to the X-ray generator and responsible for setting the energy to be applied and sending a trigger command to start X-ray irradiation,
a system programming panel, wherein the system programming panel is connected to the energy control panel and enables programming and control of hardware and software functions of the deep technology-based system.

2. The deep technology-based system according to claim 1, comprising an X-ray backup generator set connected to the X-ray tube and configured to generate the X-rays at a desired range when required.

3. The deep technology-based system according to claim 1, comprising an emergency stop button located on the energy control panel and enabling the deep technology-based system to be stopped and the functions of the deep technology-based system terminated by de-energizing the deep technology-based system in emergency situations.

4. The deep technology-based system according to claim 1, comprising an electronic control unit connected to the horizontal motion control motor, the angular scanning control motor and the vertical motion control motor and enabling control of the horizontal motion control motor, the angular scanning control motor and the vertical motion control motor.

5. The deep technology-based system according to claim 4, comprising at least two limit switches, wherein the at least two limit switches control maximum and minimum distance of movement in a horizontal axis of the angular scanning platform, wherein the at least two limit switches are connected to the horizontal motion control motor and controlled by an electronic control unit.

6. The deep technology-based system according to claim 1, comprising a detector located at a top of the angular scanning platform, opposite the X-ray tube, wherein the X-rays to be irradiated from the X-ray tube are incident perpendicularly in a horizontal plane.

7. The deep technology-based system according to claim 6, comprising a detector platform connected to a detector, wherein the detector platform is located opposite the X-ray tube and ensures that the X-rays are incident perpendicular to the detector.

8. The deep technology-based system according to claim 6, comprising a laser measuring unit in the deep technology-based system, where a laser beam is configured to determine a horizontal distance between the X-ray tube, the detector and the tumor.

9. The deep technology-based system according to claim 1, comprising leveled and adjustable legs with pneumatic sensor apparatus and an anti-vibration system, located at a bottom of the deep technology-based system, wherein it is ensured that the deep technology-based system is placed parallel and stable to a ground where the deep technology-based system sits.

10. The deep technology-based system according to claim 1, comprising an X-ray absorption shield, wherein the X-ray absorption shield surrounds the deep technology-based system and is configured to prevent the X-rays from scattering outside the deep technology-based system.

11. The deep technology-based system according to claim 1, comprising transport handles located at front and rear of the deep technology-based system, wherein the transport handles are configured for easy mobile transportation of the deep technology-based system.

12. The deep technology-based system according to claim 1, comprising advanced three-dimensional imaging software, wherein the advanced three-dimensional imaging software provides voxel-based cross-sectional and volumetric three-dimensional imaging of the tumor to determine required surgical margin and provides information about presence of the tumor in a sentinel lymph node, a first lymph node where the tumor drains.

13. The deep technology-based system according to claim 1, comprising an artificial intelligence algorithm, wherein the artificial intelligence algorithm enables mapping and reporting of required surgical margin of the tumor imaged in three dimensions.

14. The deep technology-based system according to claim 1, wherein the deep technology-based system is utilized in tumor and tumorous tissue fragments of breast, lung, liver, pancreas, thyroid, brain, skin, small intestine, large intestine, stomach, gall bladder, esophagus, bladder, kidney, ovary, uterus, cervix, testis and prostate.

15. The deep technology-based system according to claim 1, wherein the deep technology-based system provides a realization of system that enables the three-dimensional imaging of the tumor in a range of 5-25 minutes, depending on a size of the tumor.

16. A method implemented with the deep technology-based system according to claim 1, comprising the following process steps:
in order to ensure precise calculation of the beam geometry, which is critical for both three-dimensional cross-sectional and three-dimensional volumetric imaging of the tumor, moving a detector and the angular scanning platform to a starting position as a result of distance detection with a laser beam,
acquiring two-dimensional images from different angles with the detector using parameters determined by the deep technology-based system and defined by the system programming panel,
calculating dimensions of x-y-z axes of a three-dimensional image and resolutions in the x-y-z axes based on an area occupied by the tumor in acquired two-dimensional images and dimensions of an image frame,
dynamically determining the resolution based on a pixel area occupied by the tumor and the dimensions of the image frame,
thanks to the deep technology-based system, creating voxel-based cross-sectional three-dimensional images from the two-dimensional images acquired at the different angles, based on x-y-z dimensions and the resolutions across the x-y-z axes calculated by advanced three-dimensional imaging software,
mapping and reporting a required surgical margin of the tumor in each layer of three-dimensional cross-sectional images with artificial intelligence algorithm,
voxel-based volumetric visualization of the three-dimensional images.

17. The method according to claim 16, further comprising the following process steps:
by driving the horizontal motion control motor, the angular scanning platform is automatically moved to the starting position on a horizontal axis, and to the optimum distance, where a distance between the X-ray tube and the detector is calculated using the parameters determined by the system programming panel,
vertical positioning and centering of the image of the tumor on the detector with the vertical motion control motor,
acquiring two-dimensional tumor images by the detector at targeted angles and within a predetermined period of time, in line with the parameters defined for the angular scanning control motor via the system programming panel and electronic control unit.

18. The deep technology-based system according to claim 4, comprising a detector located at a top of the angular scanning platform, opposite the X-ray tube, wherein the X-rays to be irradiated from the X-ray tube are incident perpendicularly in a horizontal plane.

19. The deep technology-based system according to claim 12, comprising an artificial intelligence algorithm, wherein the artificial intelligence algorithm enables mapping and reporting of required surgical margin of the tumor imaged in three dimensions.

20. The deep technology-based system according to claim 12, wherein the deep technology-based system is utilized in tumor and tumorous tissue fragments of breast, lung, liver, pancreas, thyroid, brain, skin, small intestine, large intestine, stomach, gall bladder, esophagus, bladder, kidney, ovary, uterus, cervix, testis and prostate.
